(19) United States
(12) Patent Application Publication
(10) Pub. No.: US 2024/0065249 A1
(43) Pub. Date: Feb. 29, 2024

(54) Fishing Pole Holding Device

(71) Applicant: Jeffrey Hickerson, Wister, OK (US)

(72) Inventor: Jeffrey Hickerson, Wister, OK (US)

(21) Appl. No.: 18/456,602

(22) Filed: Aug. 28, 2023

Related U.S. Application Data
(60) Provisional application No. 63/401,336, filed on Aug. 26, 2022.

(51) Int. Cl. A01K 97/10

(52) U.S. Cl. CPC A01K 97/10

(57) ABSTRACT

A fishing pole holding device is provided. The device is comprised of a fishing pole receiving structure attached to a shaft that can be pushed into a ground surface to anchor the device during use. The receiving structure may receive a fishing pole via a plurality of cutouts and/or fasteners that secure the pole to the receiving structure such that the rod is supported during use. In this manner, a fishing rod remains secured to the device and anchored to the ground during use.

### CROSS-REFERENCE TO RELATED APPLICATION

The present application claims priority to, and the benefit of, U.S. Provisional Application No. 63/401,336, which was filed on Aug. 26, 2022, and is incorporated herein by reference in its entirety.

### FIELD OF THE INVENTION

The present invention relates generally to the field of fishing. More specifically, the present invention relates to a fishing pole holding device that can be placed into a ground surface to provide an anchor point that secures a fishing pole during use. Accordingly, the present disclosure makes specific reference thereto. Nonetheless, it is to be appreciated that aspects of the present invention are also equally applicable to other like applications, devices, and methods of manufacture.

### BACKGROUND

Fishing can be an enjoyable and rewarding outdoor activity that appeals to individuals of all ages and physical abilities, transcending generational boundaries and cultural backgrounds. For children, fishing offers an opportunity to learn patience, focus, and responsibility while developing an appreciation for the environment and wildlife. On the other hand, for the elderly, fishing can serve as a way to stay physically active and mentally engaged, promoting overall well-being and reducing stress.

However, not all individuals have the same level of physical strength and dexterity, making it challenging for some individuals to fully enjoy fishing. Elderly individuals or those with physical limitations may struggle to reel in fish, which can be disheartening and discouraging. The exertion required to lift and control a heavy fishing pole can lead to discomfort and fatigue, preventing them from fully immersing themselves in the joy of fishing.

One common problem that arises, especially for children or the elderly, is when a fish pulls the fishing pole with great force, causing it to slip out of their grasp and be pulled entirely into the water. Retrieving the lost fishing pole can be quite a predicament, and in some cases, the pole might be irretrievable, leading to additional expenses in replacing the equipment.

To address these challenges, fishing pole holders have been developed as a potential solution. These holders are designed to stabilize the fishing pole in place, allowing anglers to rest the pole securely while waiting for a fish to bite. However, the current products available in the market may have limitations in properly supporting the pole during the reeling-in process, especially when a fish is putting up a strong fight.

Therefore, there exists a long-felt need in the art for a device for supporting a fishing pole. There also exists a long-felt need in the art for a fishing pole holding device that allows elderly users, children users, and physically disabled users to easily use a fishing pole. More specifically, there exists a long-felt need in the art for a fishing pole holding device that allows elderly users, children users, and physically disabled users to easily use a fishing pole by supporting the fishing pole during use.

The subject matter disclosed and claimed herein, in one embodiment thereof, comprises a fishing pole holding device. The device is comprised of a fishing pole holding device. The device is comprised of a fishing pole receiving structure attached to a shaft. The shaft can be pushed into a ground surface to anchor the device during use. The receiving structure may receive a fishing pole via a plurality of cutouts and/or fasteners that secure the pole to the receiving structure such that the rod is supported during use.

In this manner, the fishing pole holding device of the present invention accomplishes all the forgoing objectives and provides a device for supporting a fishing pole. During use, the device allows elderly users, children users, and physically disabled users to easily use a fishing pole. To do so, the device supports a fishing pole during use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing pole holding device. The device is comprised of a first end with a pole receiving structure and a second end that can be inserted into a ground surface. The pole receiving structure receives a fishing pole such that the pole is supported by the device during use.

The first end is comprised of at least one pole receiving structure comprised of a first vertical member with a first pole receiving area, a second vertical member comprised of a second pole receiving area, and a horizontal member that attaches the vertical member to the second vertical member.

The first pole receiving area is preferably comprised of a generally V-shaped cutout that receives a fishing pole. The shape of the area prevents a fishing pole from moving downward (i.e., towards a ground surface) when secured within the pole receiving structure. The second pole receiving area is preferably comprised of a circular cutout that receives a fishing pole. The shape of the area prevents the pole from moving upward (i.e., away from the ground surface).

At least one shaft connects to the horizontal member. The second end of the device is comprised of a point which is located on the shaft. In this manner, the shaft can be pushed into a ground surface to anchor the device during use. In one embodiment, the shaft may be comprised of at least one foot peg that a user can place their foot on and kick downward to push the shaft into the ground.

The present invention is also comprised of a first method of using the device. First, a device is provided comprised of a pole receiving structure and a shaft. Then, a user can push the shaft into a ground surface and/or use at least one foot peg of the shaft to kick the shaft downward into the ground surface. Then, a fishing pole can be placed through a first pole receiving area and a second pole receiving area of the receiving structure. Next, a user can use the pole to fish while the pole is retained in and supported by the device.

In a second method of using the device, a device is provided comprised of a pole receiving structure and a shaft. Next, a user can unfold the shaft from a horizontal member of the pole receiving structure via a hinge and lock the hinge such that the shaft is relatively vertical relative to the structure. Then, a user can unfold at least one foot peg attached to the shaft via at least one hinge such that the shaft is generally perpendicular to the shaft. Then, a user can push the shaft into a ground surface and/or use at least one foot peg of the shaft to kick the shaft downward into the ground surface. Then, a fishing pole can be placed through a first pole receiving area and a second pole receiving area of the receiving structure. In one embodiment, the pole can be secured in each area via a fastener of each area. Next, a user can use the pole to fish while the pole is retained in and supported by the device.

Accordingly, the fishing pole holding device of the present invention is particularly advantageous as it provides a device for supporting a fishing pole. During use, the device allows elderly users, children users, and physically disabled users to easily use a fishing pole. To do so, the device supports a fishing pole during use. In this manner, the fishing pole holding device provides a solution to allowing elderly, children, and disabled users to fish easily.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a rear perspective view of one potential embodiment of a fishing pole holding device of the present invention in accordance with the disclosed architecture;

FIG. 2 illustrates an enhanced rear perspective view of one potential embodiment of a fishing pole holding device of the present invention in accordance with the disclosed architecture;

FIG. 3 illustrates a side view of one potential embodiment of a fishing pole holding device of the present invention in accordance with the disclosed architecture;

FIG. 4 illustrates a perspective view of one potential embodiment of a fishing pole holding device of the present invention while holding a fishing pole in accordance with the disclosed architecture

FIG. 5 illustrates a flowchart of a method of using one potential embodiment of a fishing pole holding device of the present invention in accordance with the disclosed architecture; and

FIG. 6 illustrates a flowchart of a method of using one potential embodiment of a fishing pole holding device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for supporting a fishing pole. There also exists a long-felt need in the art for a fishing pole holding device that allows elderly users, children users, and physically disabled users to easily use a fishing pole. More specifically, there exists a long-felt need in the art for a fishing pole holding device that allows elderly users, children users, and physically disabled users to easily use a fishing pole by supporting the fishing pole during use.

The present invention, in one exemplary embodiment, is comprised of a fishing pole holding device comprised of a first end with a pole receiving structure and a second end that can be inserted into a ground surface. The pole receiving structure receives a fishing pole such that the pole is supported by the device during use. The first end is comprised of at least one pole receiving structure comprised of a first vertical member with a first pole receiving area, a second vertical member comprised of a second pole receiving area, and a horizontal member that attaches the vertical member to the second vertical member.

The first pole receiving area is preferably comprised of a generally V-shaped cutout that receives a fishing pole. The shape of the area prevents a fishing pole from moving downward (i.e., towards a ground surface) when secured within the pole receiving structure. The second pole receiving area is preferably comprised of a circular cutout that receives a fishing pole. The shape of the area prevents the pole from moving upward (i.e., away from the ground surface).

At least one shaft connects to the horizontal member. The second end of the device is comprised of a point that is located on the shaft such that the shaft can be pushed into a ground surface to anchor the device during use. In one embodiment, the shaft may be comprised of at least one foot peg that a user can place their foot on and kick downward to push the shaft into the ground.

The present invention is also comprised of a first method of using the device. First, a device is provided comprised of a pole receiving structure and a shaft. Then, a user can push the shaft into a ground surface and/or use at least one foot peg of the shaft to kick the shaft downward into the ground surface. Then, a fishing pole can be placed through a first pole receiving area and a second pole receiving area of the receiving structure. Next, a user can use the pole to fish while the pole is retained in and supported by the device.

In a second method of using the device, a device is provided comprised of a pole receiving structure and a shaft. Next, a user can unfold the shaft from a horizontal member of the pole receiving structure via a hinge and lock the hinge such that the shaft is relatively vertical relative to the structure. Then, a user can unfold at least one foot peg attached to the shaft via at least one hinge such that the shaft is generally perpendicular to the shaft. Then, a user can push the shaft into a ground surface and/or use at least one foot peg of the shaft to kick the shaft downward into the ground surface. Then, a fishing pole can be placed through a first pole receiving area and a second pole receiving area of the receiving structure. In one embodiment, the pole can be secured in each area via a fastener of each area. Next, a user can use the pole to fish while the pole is retained in and supported by the device.

Accordingly, the fishing pole holding device of the present invention is particularly advantageous as it provides a device for supporting a fishing pole. During use, the device allows elderly users, children users, and physically disabled users to easily use a fishing pole. To do so, the device supports a fishing pole during use. In this manner, the fishing pole holding device provides a solution to allowing elderly, children, and disabled users to fish easily.

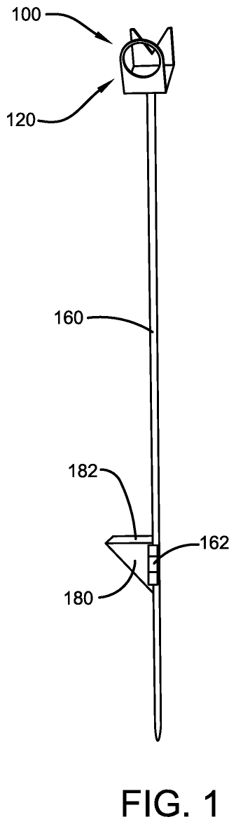

Referring initially to the drawings, FIG. 1 illustrates a rear perspective view of one potential embodiment of a fishing pole holding device 100 of the present invention in accordance with the disclosed architecture. The device 100 is comprised of a first end 110 with a pole receiving structure 120 and a second end 170 that can be inserted into a ground surface. The pole receiving structure 120 receives a fishing pole 10 such that the pole 10 is supported by the device 100 during use.

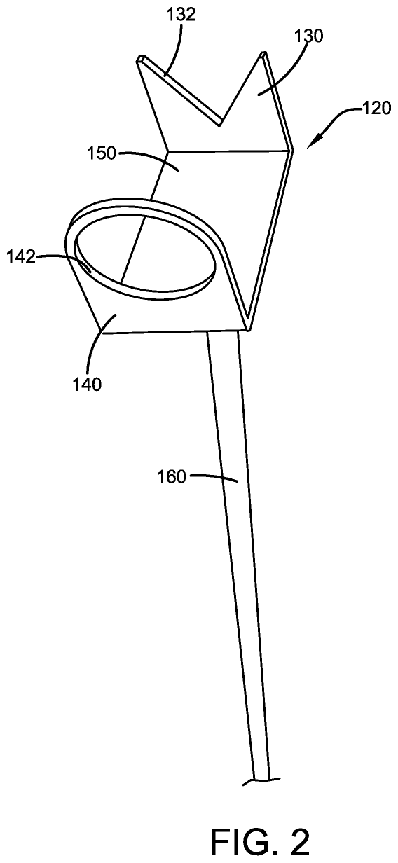

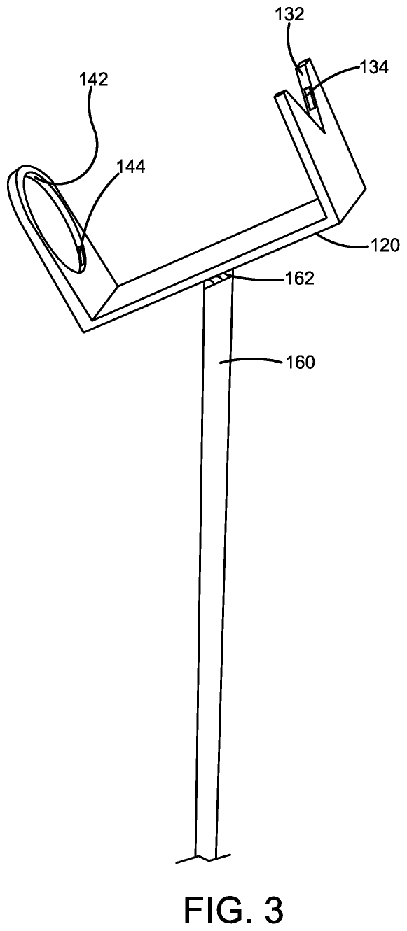

The first end 110 is comprised of at least one pole receiving structure 120, as also seen in FIG. 2 and FIG. 3. In the preferred embodiment, the structure 120 is comprised of a first vertical member 130 with a first pole receiving area 132, a second vertical member 140 comprised of a second pole receiving area 142, and a horizontal member that attaches the vertical member 130 to the second vertical member 140. The device 100 is preferably made from a durable metal or plastic material.

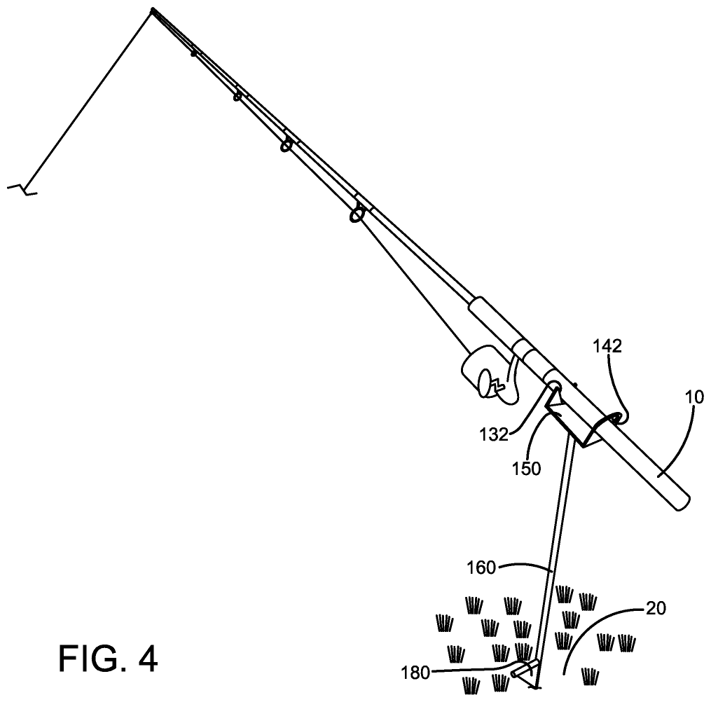

The first vertical member 130 is comprised of at least one pole receiving area 132. In one embodiment, the area 132 is comprised of a generally V-shaped cutout that receives a fishing pole 10. However, the area 132 may be any shape in a cutout embodiment. In one embodiment, the area 132 is alternatively or additionally comprised of at least one fastener 134 that secures the pole 10 to the first vertical member 130 or within the area 132. The fastener 134 may be any type known in the art such as but not limited to a clip, a clamp, a magnet, a hook and loop fastener, a snap button fastener, etc. The shape of the area 132 prevents the pole 10 from moving downward (i.e., towards a ground surface 20), as seen in FIG. 4.

The second vertical member 140 is comprised of at least one pole receiving area 142. In one embodiment, the area 142 is comprised of a circular cutout that receives a fishing pole 10. However, the area 142 may be any shape in a cutout embodiment. In one embodiment, the area 142 is alternatively or additionally comprised of at least one fastener 144 that secures the pole 10 to the second vertical member 140 or within the area 142. The fastener 144 may be any type known in the art such as but not limited to a clip, a clamp, a magnet, a hook and loop fastener, a snap button fastener, etc. The shape of the area 142 prevents the pole 10 from moving upward (i.e., away from the ground surface 20).

At least one shaft 160 connects to the horizontal member 150. In one embodiment, the shaft 160 attaches to the horizontal member 150 via at least one hinge 162. The hinge 162 may be any type but is preferably a locking hinge. The hinge 162 allows the shaft 160 to fold to transport/store the device 100 when not in use. In another embodiment, the shaft 160 is fixedly connected to the member 150.

The second end 170 of the device 100 is comprised of a point 172 which is located on the shaft 160. In this manner, the shaft 160 can be pushed into a ground surface 20 to anchor the device 100 during use. In one embodiment, the shaft 170 may be comprised of at least one foot peg 180 that a user can place their foot on and kick downward to push the shaft 160 into the ground 20. In one embodiment, the foot peg 180 is comprised of a grip area 182. The grip area 182 provides a larger surface area for a user's foot. The grip area 182 is preferably made from a non-slip rubber material or other material of the like. To further improve grip, the area 182 may be comprised of a raised or a recessed texture. In one embodiment, the peg 180 is fixedly attached to the shaft 160. In another, the peg 180 attaches to the shaft 160 via at least one hinge 162. The hinge 162 may be any type but is preferably a locking hinge. The hinge 162 allows the peg 180 to fold to transport/store the device 100 when not in use

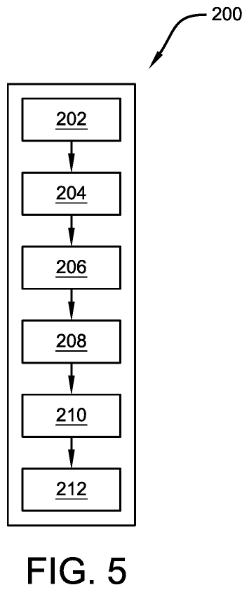

The present invention is also comprised of a method of using 200 the device 100, as seen in FIG. 5. First, a device 100 is provided comprised of a pole receiving structure 120 and a shaft 160 [Step 202]. Then, a user can push the shaft 160 into a ground surface 20 and/or use at least one foot peg 180 of the shaft 160 to kick the shaft 160 downward into the ground surface 20 [Step 204]. Then, a fishing pole 10 can be placed through a first pole receiving area 132 and a second pole receiving area 142 of the receiving structure 120 [Step 206]. In one embodiment, the pole 10 can be secured in each area 132, 134 via a fastener 134, 144 of each area 132, 142 [Step 208]. Next, a user can use the pole 10 to fish while the pole 10 is retained in and supported by the device 100 [Step 210]. A user can also remove the pole 10 from the device 100 as needed while fishing [Step 212].

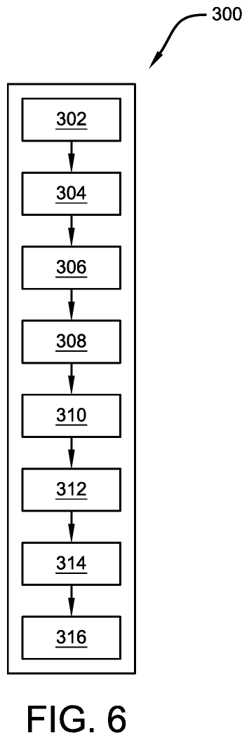

The present invention is also comprised of a second method of using 300 the device 100, as seen in FIG. 6. First, a device 100 is provided comprised of a pole receiving structure 120 and a shaft 160 [Step 302]. Next, a user can unfold the shaft 160 from a horizontal member 150 via a hinge 162 and lock the hinge 162 such that the shaft 160 is relatively vertical relative to the structure 120 [Step 304]. Then, a user can unfold at least one foot peg 180 attached to the shaft 160 via at least one hinge 162 such that the shaft is generally perpendicular to the shaft 160 [Step 306]. Then, a user can push the shaft 160 into a ground surface 20 and/or use at least one foot peg 180 of the shaft 160 to kick the shaft 160 downward into the ground surface 20 [Step 308]. Then, a fishing pole 10 can be placed through a first pole receiving area 132 and a second pole receiving area 142 of the receiving structure 120 [Step 310]. In one embodiment, the pole 10 can be secured in each area 132, 134 via a fastener 134, 144 of each area 132, 142 [Step 312]. Next, a user can use the pole 10 to fish while the pole 10 is retained in and supported by the device 100 [Step 314]. A user can also remove the pole 10 from the device 100 as needed while fishing [Step 316].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fishing pole holding device” and “device” are interchangeable and refer to the fishing pole holding device 100 of the present invention.

Notwithstanding the forgoing, the fishing pole holding device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fishing pole holding device 100 as shown in the FIGS. are for illustrative purposes only, and that many other sizes and shapes of the fishing pole holding device 100 are well within the scope of the present disclosure. Although the dimensions of the fishing pole holding device 100 are important design parameters for user convenience, the fishing pole holding device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing pole holding device comprising:
a pole receiving structure comprised of a first pole receiving area and a second pole receiving area;
a shaft attached to the pole receiving structure.

2. A fishing pole holding device of claim 1, wherein the first receiving area is comprised of a cutout.

3. A fishing pole holding device of claim 2, wherein the cutout is comprised of a V shape.

4. A fishing pole holding device of claim 1, wherein the second pole receiving area is comprised of a circular opening.

5. A fishing pole holding device of claim 1, wherein the first pole receiving area is comprised of a first fastener.

6. A fishing pole holding device of claim 5, wherein the first fastener is comprised of a clip, a clamp, a magnet, a hook and loop fastener, or a snap button fastener.

7. A fishing pole holding device of claim 1, wherein the second pole receiving area is comprised of a second fastener.

8. A fishing pole holding device of claim 7, wherein the second fastener is comprised of a clip, a clamp, a magnet, a hook and loop fastener, or a snap button fastener.

9. A fishing pole holding device of claim 1, wherein the shaft is comprised of a foot peg.

10. A fishing pole holding device of claim 1, wherein the first pole receiving area is positioned on a first vertical member of the pole receiving structure.

11. A fishing pole holding device of claim 1, wherein the second pole receiving area is positioned on a second vertical member of the pole receiving structure.

12. A fishing pole holding device comprising:
a pole receiving structure comprised of a first pole receiving area and a second pole receiving area;
a shaft attached to the pole receiving structure via a first hinge.

13. A fishing pole holding device of claim 12, wherein the first hinge is comprised of a locking hinge.

14. A fishing pole holding device of claim 12, wherein the shaft is comprised of a foot peg.

15. A fishing pole holding device of claim 14, wherein the foot peg attaches to the shaft via a second hinge.

16. A fishing pole holding device of claim 15, wherein the second hinge is comprised of a locking hinge.

17. A fishing pole holding device of claim 14, wherein the foot peg is comprised of a grip area.

18. A fishing pole holding device of claim 17, wherein the grip area is comprised of a non-slip material.

19. A fishing pole holding device of claim 17, wherein the grip area is comprised of a texture.

20. A method of using a fishing pole holding device, the method comprising the following steps:
providing a fishing pole holding device comprised of a pole receiving structure and a shaft;
pushing the shaft into a ground surface;
placing a fishing pole through a first pole receiving area and a second pole receiving area of the receiving structure to secure the fishing pole to the receiving structure; and
using the fishing pole to fish while the fishing pole is retained in and supported by the fishing pole holding device.
